(19) United States
(12) Patent Application Publication
(10) Pub. No.: US 2004/0158518 A1
(43) Pub. Date: Aug. 12, 2004

(54) Break monitoring process

(76) Inventors: Mary P. Wall, Tinton Falls, NJ (US); Bonnie Bowes, Glen Cove, NY (US); Edward C. Fennessy, Rego Park, NY (US); Karl A. Kovack, Toms River, NJ (US); Douglas Dauphinot Badeau, Hoboken, NJ (US); Thomas Albert Giacalone, Staten Island, NY (US)

Correspondence Address: Leslie Gladstone Restaino, Esq., Brown Raysman Millstein Felder & Steiner LLP, 163 Madison Avenue, P.O. Box 1989, Morristown, NJ, 07962-1989, US

(21) Appl. No.: 10/364,217

(22) Filed: Feb. 10, 2003

(51) Int. Cl. G06F 17/60

(52) U.S. Cl. 705/37

(57) ABSTRACT

The present invention provides systems and methods for tracking breaks in a networked computer system in which transactions are facilitated. The system includes a network including a mainframe computer containing a break tracking system, a plurality of trader computers, and a transaction information database. The database contains at least two sets of information associated with a first transaction. The break tracking system allows comparison of the at least two sets of information to determined whether a break exists. If a break is determined to exist, the break tracking system allows identification of one or more traders evidenced in the networked computer system as being associated with the break, can allow providing electronic notification of the break to trader computers associated with the traders, and can provide a break tracking application facilitating electronic communication between users of trader computers for facilitating resolution of the break.

### BACKGROUND OF THE INVENTION

1. Field of the Invention

The present invention relates to financial business systems; and more particularly, to systems and methods for tracking breaks.

2. Description of the Related Art

Computerized systems in which transactions are facilitated, including, for example, various financial services systems and trading systems, are known in the art. As in many other fields of endeavor, such computerized systems can offer numerous advantages over less computerized or non-computerized systems.

Transactions facilitated by computerized systems, such as, for example, many transactions associated with Wall Street, are often complex. A simple transaction may include execution of a buy order. A more complex transaction, on the other hand, can be made up of a series of linked or associated computerized executed orders, and can involve computers or computer systems of multiple trading entities, such as intermediary brokers and non-broker traders.

For example, suppose a trader, such as a customer of a broker, Broker A, electronically places a buy order with Broker A for a particular quantity of a particular security at a current market price. Herein, the term, “security” is broadly intended to include various rights, interests, or entitlements associated with securities, such as options, mortgage interests, government securities, derivatives, equities, fixed income securities, and others. Of course, more complex orders are possible, having various other or additional order details, or orders which are split or combined into other orders, etc., but a simple example of an order will suffice for illustration purposes. After Broker A receives the customer's buy order, in an effort to progress toward fulfilling the order, Broker A, for example, electronically transmits an associated buy order to another broker, Broker B. Broker A may use Broker B for any number of reasons. For example, Broker B may be in a better position to be able to rapidly fulfill an order for the security in question, or may be able to obtain the securities more cheaply than Broker A. After receiving the buy order from Broker A, Broker B electronically executes an associated buy order, for example, itself or through a listed exchange.

The ability to rapidly transmit and execute orders using computers can make complex transactions, such as the above-described transaction, rapid and practical. Naturally, the traders involved in the above-described transaction will generally keep records of orders in which they are involved, including orders that they execute. They may keep electronic records, or paper records, or both.

Before settlement associated with the above described transaction, verification, in some form, will generally be made to ensure that there are no breaks, i.e., anomalies, inconsistencies or discrepancies with regard to the particulars of the orders. This ensures proper accounting. For example, since Broker B executed a sell order to accommodate broker A's buy order, generally, the details of the orders, e.g., the security, quantity, price, etc. must match. Ideally, of course, no breaks will be present and settlement can occur with respect to the executed orders. In reality, however, breaks do occur. Breaks can occur for a variety of reasons, including, for example, human error.

Suppose, for example, that, after receiving Broker A's buy order, a Broker B entered a corresponding buy order into his or her computer system, to be executed through the New York Stock Exchange. Broker B, however, made a data entry error when entering the quantity. When Broker B executed the order through the New York Stock Exchange, a break therefore occurred, in that the terms of Broker B's buy order do not match the terms of Broker A's buy order, with which Broker B's order is associated. Prior to settlement, during the verification, the break is discovered. Resolution of the break, however, can be difficult, inefficient, and expensive. Additionally, since settlement will likely occur within several days, timely resolution of the break is essential. Typically, employees at Broker B's offices will confer with employees at Broker A's offices to attempt to resolve the break. In this regard, the employees may use records such as a daily transaction print report.

Numerous orders as well as numerous computers and computer systems are often involved in a complex transaction, and there can be many points at which breaks can, and do, occur. For example, use of multiple non-integrated or semi-integrated computers or computer systems can contribute to the possibility of a break occurring. Furthermore, even if breaks occur in a small percentage of executed orders or transactions, they naturally become more numerous as the quantity of executed orders and transactions becomes more numerous. More numerous orders and transactions, however, are a natural and desirable result of using computer systems to facilitate transactions. Breaks not found during a verification phase cause accounting problems and inefficiencies. Once a break is found, identifying traders associated with the break can be a further problem. Finally, resolving identified breaks is generally slow, expensive and inefficient.

For all of the above reasons, there is a need in the art for a more efficient system for identifying and facilitating resolution of breaks in computerized systems in which transactions are facilitated.

### SUMMARY OF THE INVENTION

The present invention provides break tracking systems and methods in a networked computer system in which transactions are facilitated. The networked computer system can be or include, for example, a financial services system or extended financial services system that facilitates transactions in financial instruments such as securities. The networked computer system includes a mainframe computer containing a break tracking system, a plurality of trader computers for use in communicating orders associated with the transactions to a market, and a transaction information database for storing information about the transactions. The database contains at least two sets of information associated with a first transaction, at least one of the sets of information being associated with the market, and at least one of the sets of information being associated with a trader associated with at least one of the trader computers.

In some embodiments, the break tracking system is used to identify, i.e., detect and obtain information about, breaks, as well as to identify users of the extended financial services system associated with breaks. Herein, the term “user” is broadly intended to include computers or computer systems as well as entities such as brokers, individuals, or other trader entities that use computers or computer systems. In some embodiments, the break tracking system is utilized to provide electronic notification of breaks to trader computers. In some embodiments, the break tracking system is utilized to provide a break tracking application facilitating electronic communication between users of trader computers, for facilitating resolution of the break. Furthermore, in some embodiments, if a break remains unresolved after a predetermined time prior to settlement of an associated transaction, the break tracking system is utilized to provide an electronic posting to a suspense account of a trader determined to have executed an order associated with the break, the posting accounting for the break.

In one embodiment, the invention provides, in a networked computer system in which transactions are facilitated, a system for tracking breaks, the system including: a first set of one or more computers connected to a network, the first set of computers including a break tracking system; a plurality of trader computers, connected to the network, for use in communicating orders associated with the transactions to a market; and a transaction information database, accessible by at least one of the first set of computers, for storing information about the transactions. The database contains at least two sets of information associated with a first transaction of the transactions, at least one of the sets of information being associated with the market, and at least one of the sets of information being associated with a trader associated with at least one of the trader computers. The break tracking system is for: comparing the at least two sets of information to determine whether a break exists; and, if a break is determined to exist: identifying a set of at least one trader evidenced in the networked computer system as being associated with the break; and providing, through the network, electronic notification of the break to a first trader computer of the plurality of trader computers, the first trader computer being associated with at least one trader of the first set of at least one trader.

In another embodiment, the invention provides, in a networked computer system for facilitating transactions, a system for tracking breaks, the system including: a first set of one or more computers connected to a network, the first set of computers including a break tracking system; a plurality of trader computers, connected to the network, for use in communicating orders associated with the transactions to a market; and a transaction information database, accessible by at least one of the first set of computers, for storing information about the transactions. The database contains at least two sets of information associated with a first transaction of the transactions, at least one of the sets of information being associated with the market, and at least one of the sets of information being associated with a trader associated with at least one of the trader computers. The break tracking system is for: comparing the at least two sets of information to determine whether a break exists; and, if a break is determined to exist: identifying a set of at least one trader evidenced in the networked computer system as being associated with the break; and providing, through the network, for use of users of trader computers including at least one trader computer that is associated with at least one trader of the set of at least one trader, a break tracking application, the break tracking application facilitating electronic communication between users of trader computers, for facilitating resolution of the break.

In another embodiment, the invention provides, in a networked computer system in which transactions are facilitated, a system for tracking breaks, the system including: a first set of one or more computers connected to a network, the first set of computers including a break tracking system; a plurality of trader computers, connected to the network, for use in communicating orders associated with the transactions to a market; and a transaction information database, accessible by at least one of the first set of computers, for storing information about the transactions. The database contains at least two sets of information associated with a first transaction of the transactions, at least one of the sets of information being associated with the market, and at least one of the sets of information being associated with a trader associated with at least one of the trader computers. The break tracking system is for: comparing the at least two sets of information to determine whether a break exists; and, if a break is determined to exist: identifying a set of at least one trader evidenced in the networked computer system as being associated with the break; providing, through the network, electronic notification of the break to a first trader computer of the plurality of trader computers, the first trader computer being associated with at least one trader of the set of at least one trader; and providing, through the network, for use of users of trader computers including at least one trader computer that is associated with at least one trader of the set of at least one trader, a break tracking application, the break tracking application facilitating electronic communication between users of trader computers, the electronic communication being for facilitating resolution of the break.

In another embodiment, the invention provides, in a networked computer system in which transactions are facilitated, a system for tracking breaks, the system including: a first set of one or more computers connected to a network, the first set of computers including a break tracking system; a plurality of trader computers, connected to the network, for use in communicating orders associated with the transactions to a market; and a transaction information database, accessible by at least one of the first set of computers, for storing information about the transactions. The database contains at least two sets of information associated with a first transaction of the transactions, at least one of the sets of information being associated with the market, and at least one of the sets of information being associated with a trader associated with at least one of the trader computers. The break tracking system is for: comparing the at least two sets of information to determine whether a break exists; and, if a break is determined to exist: identifying a set of at least one trader evidenced in the networked computer system as being associated with the break; providing, through the network, electronic notification of the break to a first trader computer of the plurality of trader computers, the first trader computer being associated with at least one trader of the first set of at least one trader; providing, through the network, for use of users of trader computers including at least one trader computer that is associated with at least one trader of the set of at least one trader, a break tracking application, the break tracking application facilitating electronic communication between users of trader computers, the electronic communication being for facilitating resolution of the break; and, if the break remains unresolved after a predetermined time prior to settlement associated with the first transaction, providing an electronic posting to a suspense account of a trader determined to have executed an order associated with the break, the posting accounting for the break.

In another embodiment, the invention provides, in a networked computer system in which transactions are facilitated, the networked computer system including a first set of one or more computers including a break tracking system, a plurality of trader computers for use in communicating orders associated with the transactions to a market, and a transaction information database, accessible by at least one of the first set of computers, for storing information about the transactions, in which the database contains at least two sets of information associated with a first transaction of the transactions, at least one of the sets of information being associated with the market, and at least one of the sets of information being associated with a trader associated with at least one of the trader computers, a method for tracking breaks. The method includes: utilizing the break tracking system, comparing the at least two sets of information to determine whether a break exists; and, if a break is determined to exist: identifying a set of at least one trader evidenced in the networked computer system as being associated with the break; and providing, through the network, electronic notification of the break to a first trader computer of the plurality of trader computers, the first trader computer being associated with at least one trader of the first set of at least one trader.

In another embodiment, the invention provides, in a networked computer system in which transactions are facilitated, the networked computer system including a first set of one or more computers including a break tracking system, a plurality of trader computers for use in communicating orders associated with the transactions to a market, and a transaction information database, accessible by at least one of the first set of computers, for storing information about the transactions, in which the database contains at least two sets of information associated with a first transaction of the transactions, at least one of the sets of information being associated with the market, and at least one of the sets of information being associated with a trader associated with at least one of the trader computers, a method for tracking breaks. The method includes: utilizing the break tracking system, comparing the at least two sets of information to determine whether a break exists; and, if a break is determined to exist: identifying a set of at least one trader evidenced in the networked computer system as being associated with the break; and providing, through the network, for use of users of trader computers including at least one trader computer that is associated with at least one trader of the set of at least one trader, a break tracking application, the break tracking application facilitating electronic communication between users of trader computers, the electronic communication being for facilitating resolution of the break.

In another embodiment, the invention provides, in a networked computer system in which transactions are facilitated, the networked computer system including a first set of one or more computers including a break tracking system, a plurality of trader computers for use in communicating orders associated with the transactions to a market, and a transaction information database, accessible by at least one of the first set of computers, for storing information about the transactions, in which the database contains at least two sets of information associated with a first transaction of the transactions, at least one of the sets of information being associated with the market, and at least one of the sets of information being associated with a trader associated with at least one of the trader computers, a method for tracking breaks. The method includes: utilizing the break tracking system, comparing the at least two sets of information to determine whether a break exists; and, if a break is determined to exist: identifying a set of at least one trader evidenced in the networked computer system as being associated with the break; providing, through the network, electronic notification of the break to a first trader computer of the plurality of trader computers, the first trader computer being associated with at least one trader of the first set of at least one trader; and providing, through the network, for use of users of trader computers including at least one trader computer that is associated with at least one trader of the set of at least one trader, a break tracking application, the break tracking application facilitating electronic communication between users of trader computers, for facilitating resolution of the break.

In another embodiment, the invention provides, in a networked computer system in which transactions are facilitated, the networked computer system including a first set of one or more computers including a break tracking system, a plurality of trader computers for use in communicating orders associated with the transactions to a market, and a database, accessible by at least one of the first set of computers, for storing information about the transactions, a method for tracking breaks. The method includes: communicating to and storing in the database at least two sets of information associated with a first transaction of the transactions, at least one of the sets of information being associated with the market, and at least one of the sets of information being associated with a trader associated with at least one of the trader computers; utilizing the break tracking system, comparing the at least two sets of information to determine whether a break exists; and if a break is determined to exist: identifying a set of at least one trader evidenced in the networked computer system as being associated with the break; providing, through the network, electronic notification of the break to a first trader computer of the plurality of trader computers, the first trader computer being associated with at least one trader of the first set of at least one trader; and providing, through the network, for use of users of trader computers including at least one trader computer that is associated with at least one trader of the set of at least one trader, a break tracking application, the break tracking application facilitating electronic communication between users of trader computers, for facilitating resolution of the break.

In another embodiment, the invention provides, in a networked computer system in which transactions are facilitated, the networked computer system including a first set of one or more computers including a break tracking system, a plurality of trader computers for use in communicating orders associated with the transactions to a market, and a transaction information database, accessible by at least one of the first set of computers, for storing information about the transactions, in which the database contains at least two sets of information associated with a first transaction of the transactions, at least one of the sets of information being associated with the market, and at least one of the sets of information being associated with a trader associated with at least one of the trader computers, a method for tracking breaks, a method for tracking breaks. The method includes: utilizing the break tracking system, comparing the at least two sets of information to determine whether a break exists; and, if a break is determined to exist: identifying a set of at least one trader evidenced in the networked computer system as being associated with the break; providing, through the network, electronic notification of the break to a first trader computer of the plurality of trader computers, the first trader computer being associated with at least one trader of the first set of at least one trader; providing, through the network, for use of users of trader computers including at least one trader computer that is associated with at least one trader of the set of at least one trader, a break tracking application, the break tracking application facilitating electronic communication between users of trader computers, the electronic communication being for facilitating resolution of the break; and, if the break remains unresolved after a predetermined time prior to settlement associated with the first transaction, providing an electronic posting to a suspense account of a trader determined to have executed an order associated with the break, the posting accounting for the break.

In another embodiment, the invention provides, in a networked computer system in which transactions are facilitated, the networked computer system including a first set of one or more computers including a break tracking system, a plurality of trader computers for use in communicating orders associated with the transactions to a market, and a transaction information database, accessible by at least one of the first set of computers, for storing information about the transactions, in which the database contains at least two sets of information associated with a first transaction of the transactions, at least one of the sets of information being associated with the market, and at least one of the sets of information being associated with a trader associated with at least one of the trader computers, a computer usable medium storing program code which, when executed by the mainframe computer, causes the mainframe computer to execute a method for tracking breaks. The method includes: utilizing a break tracking system executed by the mainframe computer, comparing the at least two sets of information to determine whether a break exists; and, if a break is determined to exist: identifying a set of at least one trader evidenced in the networked computer system as being associated with the break; providing, through the network, electronic notification of the break to a first trader computer of the plurality of trader computers, the first trader computer being associated with at least one trader of the first set of at least one trader; and providing, through the network, for use of users of trader computers including at least one trader computer that is associated with at least one trader of the set of at least one trader, a break tracking application, the break tracking application facilitating electronic communication between users of trader computers, for facilitating resolution of the break.

Additional aspects of the present invention will be apparent in view of the description which follows.

### BRIEF DESCRIPTION OF THE FIGURES

The invention is illustrated in the figures of the accompanying drawings which are meant to be exemplary and not limiting, in which like references are intended to refer to like or corresponding parts, and in which:

FIG. 1 is a block diagram of a distributed computer system according to one embodiment of the invention, depicting a break occurring at an internal trader computer;

FIG. 2 is a block diagram of a distributed computer system according to another embodiment of the invention, depicting a break occurring at an correspondent trader computer;

FIG. 3 is a detailed block diagram of a distributed computer system according to one embodiment of the invention;

FIG. 3A is a block diagram of a system according to one embodiment of the invention;

FIG. 4 is a flow diagram of a method according to one embodiment of the invention, including providing electronic notification of a break;

FIG. 5 is a flow diagram of a method according to another embodiment of the invention, including providing a break tracking application;

FIG. 6 is a flow diagram of a method according to another embodiment of the invention, including providing electronic notification of a break and providing a break tracking application;

FIG. 7 is a flow diagram of a method according to another embodiment of the invention, including providing electronic notification of a break, providing a break tracking application, and providing an electronic posting to a user's account to account for the break;

FIG. 8 is a break tracking application main menu graphical user interface, according to one embodiment of the invention;

FIG. 9 is an over the counter (OTC) securities graphical user interface, of the application of FIG. 8;

FIG. 10 is a break details graphical user interface, of the application of FIG. 8;

FIG. 11A is a first screen display of a standard break comment selection graphical user interface, of the application of FIG. 8;

FIG. 11B is a second screen display of a standard break comment selection graphical user interface, of the application of FIG. 8;

FIG. 12 is a break summary graphical user interface, including a standard comment inserted by a user, of the application of FIG. 8;

FIG. 13 is a break summary graphical user interface, including a free form comment inserted by a user, of the application of FIG. 8;

FIG. 14 is a break summary graphical user interface, including a reply comment by a user, of the application of FIG. 8;

FIG. 15 is a break summary graphical user interface which results from a user search query, of the application of FIG. 8;

FIG. 16 is an break auto-book graphical user interface, listing breaks that will be posted to trader's account if not resolved by a specified time, of the application of FIG. 8;

FIG. 17 is a break summary history graphical user interface, providing a log of past breaks, of the application of FIG. 8; and

FIG. 18 is a break summary history graphical user interface, providing a log of past comments associated with a break, of the application of FIG. 8.

### DETAILED DESCRIPTION OF THE INVENTION

In the following description of the preferred embodiment, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

The present invention provides break tracking systems and methods in a networked computer system in which transactions are facilitated. The networked computer system can be or include, for example, a financial services system or extended financial services system that facilitates transactions in financial instruments such as securities. The networked computer system includes mainframe computer containing a break tracking system, a plurality of trader computers for use in communicating orders associated with the transactions to a market, and a transaction information database for storing information about the transactions. The database contains at least two sets of information associated with a first transaction, at least one of the sets of information being associated with the market, and at least one of the sets of information being associated with a trader associated with at least one of the trader computers.

In some embodiments, the break tracking system is utilized to provide electronic notification of breaks to trader computers. In some embodiments, the break tracking system is utilized to provide a break tracking application facilitating electronic communication between users of trader computers, for facilitating resolution of the break. Furthermore, in some embodiments, if a break remains unresolved after a predetermined time prior to settlement of an associated transaction, the break tracking system is utilized to provide an electronic posting to a suspense account of a trader determined to have executed an order associated with the break, the posting accounting for the break.

The systems described in following published international applications contain features which can be used in the practice of various embodiments of the present invention, and each is hereby incorporated herein by reference in its entirely: published international application no. WO 01/50317, published on Jul. 12, 2001 and entitled, “On-Line Trading System”; published international application no. WO 01/61590, published on Aug. 23, 2001 and entitled, “System for Providing Financial Services”; published international application no. WO 01/61589, published on Aug. 23, 2001 and entitled, “Browser Interface and Network Based Financial Services System”; and, published international application no. WO 01/61535, published on Aug. 23, 2001 and entitled, “System and Method for Execution of Trades Made Pursuant to Stock Option and Purchase Plans.” Additionally, commonly owned U.S. patent application Ser. No. 10/026,747, filed on Dec. 20, 2001 and entitled, “System and Method for Facilitating Securities Borrowing Transactions” contains features which can be used in the practice of various embodiments of the present invention, and is hereby incorporated herein by reference in its entirety. The present invention can be utilized and implemented within a variety of financial services platforms, such as any of those described in the above applications.

In some embodiments, the systems and methods of the present invention can be utilized in combination with the systems and methods for facilitating securities borrowing transactions as described in U.S. patent application Ser. No. 10/026,747, For example, in some embodiments of the present invention, the customer client program, ASAP server program, and trading desk program as described in U.S. patent application Ser. No. 10/026,747 can be stored in data storage devices 302, 304, 306 of customer computer 102, mainframe computer 112, and trader computers 116_{a-c}, respectively, as described herein. Further, in some embodiments of the present invention, the information stored in the securities database, as described in U.S. patent application Ser. No. 10/026,747, can be included in the information stored transaction information database 118, as described herein, or can be a separate database included in systems of the present invention. In addition, any breaks occurring in securities borrowing transactions, as described in U.S. patent application Ser. No. 10/026,747, can be tracked by the various systems and methods of the present invention.

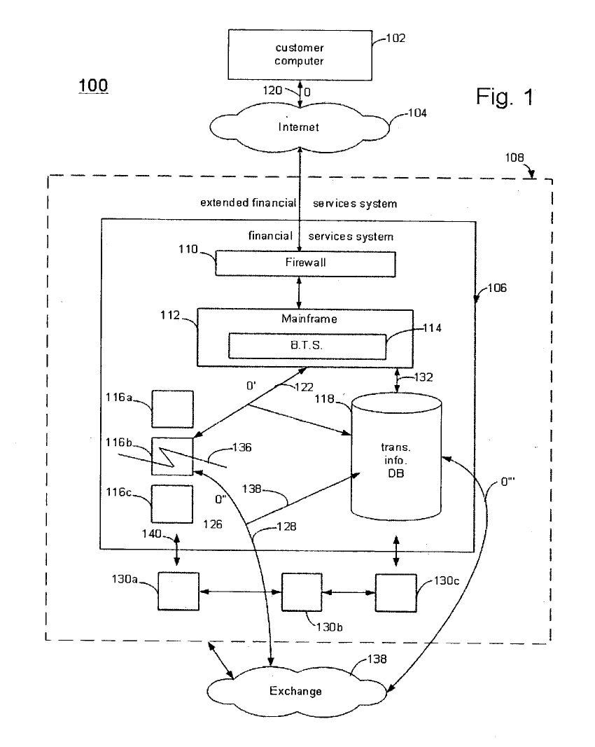

FIG. 1 is a block diagram of a distributed computer system 100 according to one embodiment of the invention, depicting a break occurring at an internal trader computer 116_{b}. As depicted in FIG. 1, the Internet 104 connects one or more customer computers 102 with a financial services system 106, the financial services system 106 being within an extended financial services system 108. Outside the financial services system 106, but inside the extended financial services system 108, are correspondent trader computers 130_{a-c}. Although the Internet 104 is depicted, the invention contemplates embodiments in which the customer computer 102 is connected to the extended financial services system 108 in other ways, such as by other networks which can include personal area networks (PANs), local area networks (LANs) or wide area networks (WANs), and the invention contemplates embodiments in which no Internet connection is provided. In addition, in various embodiments, the customer computer can be located within the extended financial services system 108 or within the financial services system 106.

The extended financial services system 108, or a portion or portions thereof, is connected with an exchange 138. The exchange 138 can represent, for example, the New York Stock Exchange or any network or system in through which transactions can be accomplished, as well as represent transactions accomplished using such networks or systems.

One or more firewalls 110, as known in the art, such as a packed filter firewall, circuit gateway firewall, application gateway firewall, or trusted gateway firewall, which can comprise various hardware and software, provides secured access to one or more mainframe computers 112 within the financial services system 106. Also within the financial services system 106 are internal trader computers 116_{a-c} and transaction information database 118. In alternative embodiments, the transaction information database 118 can be incorporated into the mainframe computer 112 or be located elsewhere.

The mainframe computer 112 is connected to the internal trader computers 116_{a-c} and to the transaction information database 118. The internal trader computers 116_{a-c} are connected to the mainframe computer 112 and the database 118, and, in some embodiments, can also be connected to each other, correspondent trader computers 130_{a-c}, and the exchange 138. As indicated by double-headed arrow 140, the correspondent trader computers 130_{a-c} are connected to the internal trader computers 116_{a-c} and, as indicted by double-headed arrow 142, to the transaction information database 118.

Each of the extended financial services system 108 and the financial services system 106 can be broadly described as a system in which transactions are facilitated. For example, the financial services system 108 can be associated with a financial services company, such as a company, hereinafter referred to as the primary company, which facilitates transactions in financial securities such as stocks or bonds. The customer computer 102 broadly represents a computer of an individual person, broker, branch office, or other entity who utilizes the services of the primary company. For example, in some embodiments, the user of the customer computer 102 accesses, via the Internet 104, the Web site of the primary company, and places orders to buy or sell securities through the Web site interface, which interface can be secured or otherwise. The internal trader computers 116_{a-c} can be, for example, trading desk computers or broker computers associated with the primary company, or with various departments or other sub-entities within the primary company.

The correspondent trader computers 130_{a-c} can be, for example, computers used by correspondent companies, such as brokers, which have a relationship with and transact with the primary company or elements thereof. For example, in some embodiments, entities, such as trading desks, associated with the primary company utilize the services of the correspondent company in order to accommodate or fulfill orders and transactions. As such, internal traders using internal trader computers, such as the internal trader computers 116_{a-c}, can place orders with correspondent companies, and vice-versa, by communication with correspondent company computers such as the correspondent company computers 130_{a-c}. In addition, internal traders can place orders and transact with each other, as can correspondent companies, via communication between the respective associated computers.

In some embodiments, communication between the internal trader computers 116_{a-c} and the mainframe computer 112, or one or more other computers within the financial services system 106 is facilitated by one or more applications or programs executed from one or more computers which can act as intermediaries.

Also, in some embodiments, communication between the correspondent company computers 130_{a-c} the financial services system 106 is facilitated by one or more applications being executed from one or more computers which can act as intermediaries. For example, in some embodiments, the correspondent company computers 130_{a-c} access an application or program being executed by an Internet-based computer, such as an applet written in the Java™ programming language and embedded in a Hypertext Markup Language Web page.

In FIG. 1, one embodiment of a complex transaction involving multiple executed orders is depicted. The customer, using the customer computer 102, places a securities order, depicted as an “O”, such as a buy order for a particular quantity of a particular security at a particular price per unit, with the primary company via communication with the mainframe computer 112. The mainframe computer 112 communicates an associated order, O′, such as an order intended to be identical with order O, to the internal trader computer 116_{b}. A user of the internal trader computer 116_{b} causes the internal trader computer 116_{b} to communicate an associated order, O″, such as an order intended to be identical with order O′, to the exchange 138. Through the exchange 138, order O″ is executed. With the evident availability of the securities, execution of orders O′ and O is enabled and accomplished. Orders O, O′, and O″ follow a conceptual flow as in part indicated by double-headed arrows 120, 122, and 126. Orders O, O′, and O″ can be viewed as all being associated with a single first transaction originating with order O and culminating in execution of order O through intermediary orders O′, and O″.

While FIGS. 1-3 depict a customer computer 102 submitting an order over the Internet 104, it is to be understood that orders can be communicated from the extended financial services system 108 to the exchange 138 without having been received from a customer computer 102 or over the Internet 104, and, in some embodiments of the invention, there is no Internet connection, no customer computer 102, or no communication of orders over the Internet 104.

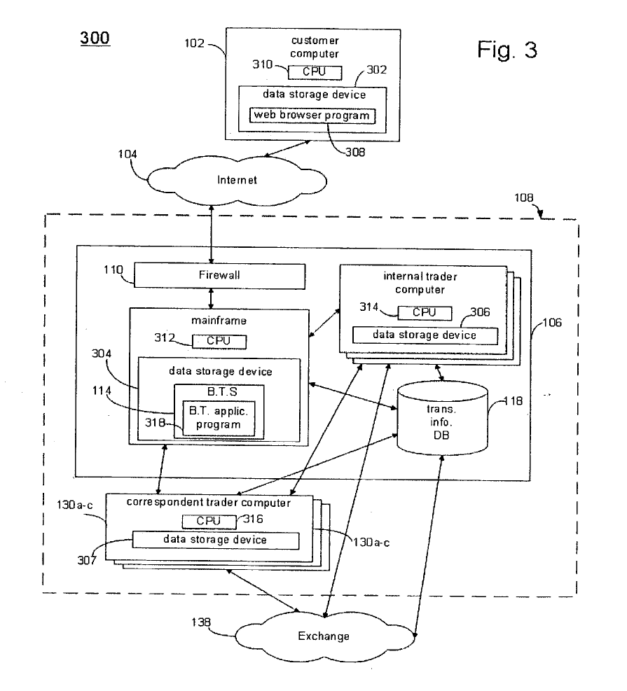

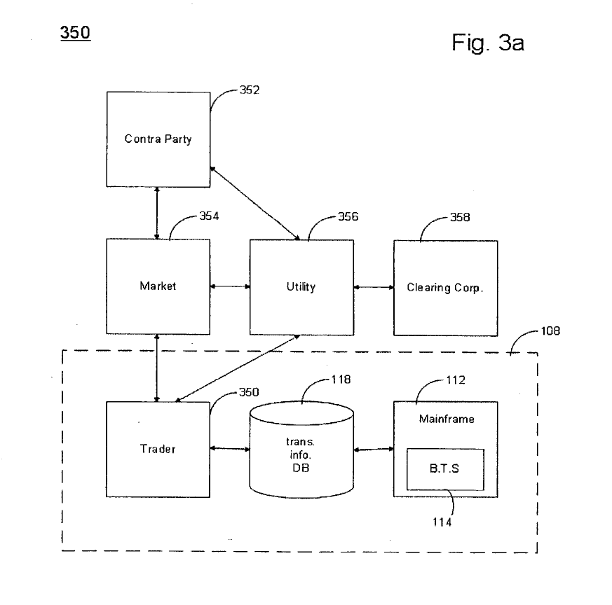

After the mainframe computer 112 receives the order O, in addition to communicating the order O to the internal trader computer 116_{b}, the mainframe computer 112 also communicates the order O to the transaction information database 118, the conceptual flow of which communication is indicated by double-headed arrow 132. Furthermore, when the mainframe computer 112 communicates the order O′ to the internal trader computer 116_{b}, the mainframe computer 112 also communicates the order O′ to the transaction information database 118, the conceptual flow of which communication is indicated by arrow 124. Still further, when the internal trader computer 116_{b} communicates the order O″ to the exchange 138, the internal trader computer 116_{b} also communicates the order O″ to the transaction information database 118, the conceptual flow of which communication is indicated by arrow 138. Additionally, arrow O′″ indicates that order information in connection with the exchange 138 is communicated to the transaction information database 118 (see the discussion herein with reference to FIG. 3A).

The orders O, O′, and O″, including their various particulars, are thereby all communicated to, and are saved in, the transaction information database 118. In alternative embodiments, the orders O, O′, and O″ are communicated at other times, such as separately from and after communication of the orders O, O′, and O″ between the customer computer 102, mainframe computer 112, internal trader computers 116_{a-c}, and the exchange 138. In addition, in some embodiments, one or more of the orders O, O′, and O″ are communicated to one or more intermediate sources or computers before being communicated ultimately to the transaction information database 118. Furthermore, the orders O, O′, and O″ are saved in the database in association with each other and the first transaction, for example, by being saved in association with a transaction number representing the first transaction. In some embodiments, they are also saved in a manner indicating their association with each other, i.e., O being the first in the chain of orders, O'being the second, and O″ being the third.

Additional information can also be saved in association which the orders O, O′, and O″, such as the date and time of their communication to various entities, the entities from which information is transmitted to the transaction information database 118, the entities which execute particular orders, the date and time of execution of particular orders, etc., some of which additional information can be sent to the transaction information database 118 at different times from the communications discussed above. Furthermore, additional orders can be involved in accomplishing the transaction, although not discussed above, such as orders communicated from the exchange to the internal trader computer 116_{b}, or from the internal trader computer 116_{b} to the mainframe computer 112. Information regarding such additional orders can also be communicated to the transaction information database, in a manner which can be similar to that described above with respect to orders O, O′, and O″. Still further, the transactional database 118 can contain information associating particular trader computers with particular entities, such as a broker or company associated with a particular trader computer. Alternatively, this and other information can be stored elsewhere from the transaction information database 118, such as in a different database or databases connected to the mainframe computer 112. At some time after the execution of all of the orders O, O′, and O″, settlement is accomplished, i.e., appropriate funds transfers are made.

As conceptually depicted by symbol 136, a break occurs in conceptual association with the internal trader computer 116_{b}, which break can arise from any number of possible causes, whether human error or otherwise. For example, suppose that, after the internal trader computer 116_{b} receives order O′, a user of the internal trader computer 116_{b}, manually enters, using a keyboard of the internal trader computer 116_{b} and via a software application used to interface with a computer associated with the exchange 138, the particulars of the order O″, which particulars are intended to be identical to the particulars of order O′. The user, however, makes a manual error, for example, by entering in a quantity of shares which is different from a quantity indicated by the particulars of order O′. Order O″ is then executed, and a break has arisen in that the order O′ is discrepant with respect to order O″.

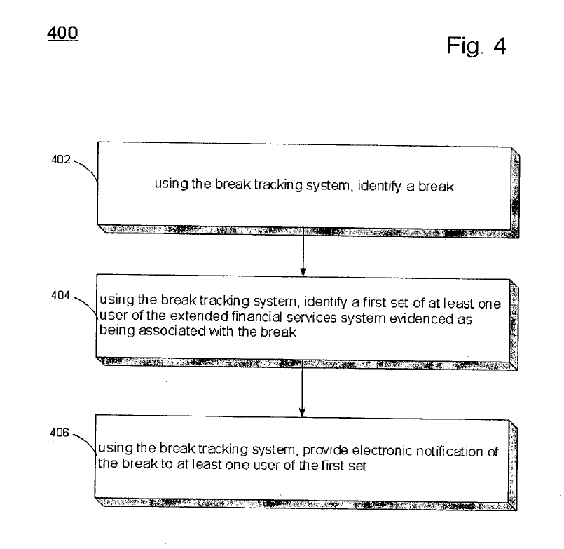

As will be described in detail with regard to FIGS. 4-18, the mainframe computer 112, utilizing a break tracking system 1114, can use the information stored in the transaction information database 118, which can include information regarding the orders O, O′, and O″, in identifying the break and identifying a “break owner”, i.e., an entity evidenced by the information stored in the transaction information database as being the entity that is responsible for execution of, or has communicated to a market, the order from which the break arose. The entity or computer on the opposite side of the order from which the break arose is termed a contra entity, such as a contra broker. Generally, orders are communicated to the Exchange 138 from the contra entity as well as from the extended financial services system 108 (see the discussion with reference to FIG. 3A herein). In the example depicted in FIG. 1, the break owner would be an entity associated with the internal trader computer 116_{b} Other aspects of the invention, including providing electronic notification and providing a break tracking application, will be described with respect to later figures.

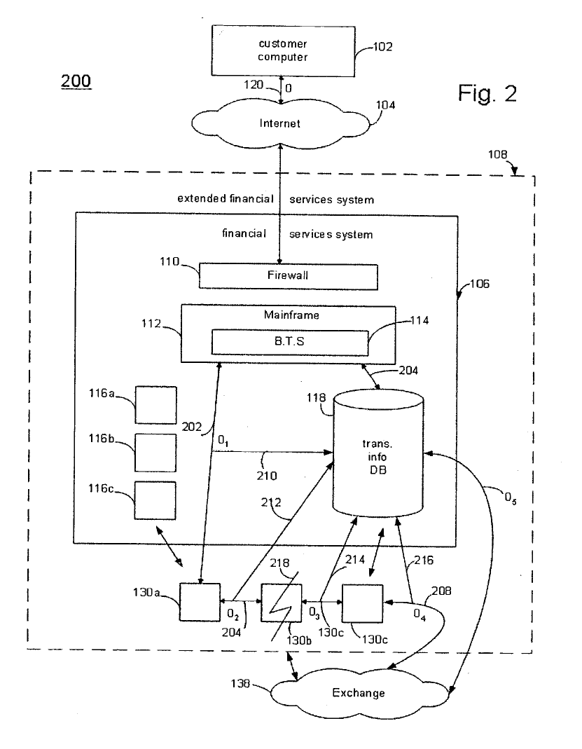

FIG. 2 is a block diagram of a distributed computer system 200 according to another embodiment of the invention, depicting a break occurring in conceptual association with the correspondent trader computer 130_{b}. The system 200 depicted in FIG. 2 is identical in components with the system 100 depicted in FIG. 1; however, the depicted occurrences differ, including the flow of orders associated with a transaction, and the occurrence of a break. As depicted in FIG. 2, the order O is communicated from the customer computer 102 to the mainframe computer 112 over the Internet. An associated order 01 is then communicated to the correspondent trader computer 130ₐ, the flow of which communication is indicated by double-headed arrow 202. Subsequently, the associated orders 02, 03, and 04 are communicated, respectively, from the correspondent trader computer 130ₐ to the correspondent trader computer 130_{b}, then from the correspondent trader computer 130_{b} to the correspondent trader computer 130_{c}, then from the correspondent trader computer 130_{c} to the exchange 138, the conceptual flow of which communications are depicted, respectively, by the arrows 204, 206, and 208.

As depicted in FIG. 2, a break occurs in conceptual association with correspondent trader computer 130_{b}, as conceptually depicted by symbol 218. Information about communicated orders is transmitted to the transaction information database 118 upon communication of the orders O, O₁, O₂, O₃, and O₄, as conceptually depicted by arrows 209, 210, 212, 214, and 216. The orders O, O₁, O₂, O₃, and O₄ are all associated with a single transaction which can be viewed as originating with the communication of the order O from the customer computer 102 to the mainframe computer 112, and culminating in execution of order O through intermediary orders O₁, O₂, O₃, and O₄.

The mainframe computer 112, utilizing the break tracking system 114, can use the information stored in the transaction information database 118, which can include information regarding orders O, O₁, O₂, O₃, and O₄, in identifying the break as well as identifying the correspondent trader computer 130_{b} as the break owner, and in identifying correspondent trader computer 130_{c} as the contra entity. Other aspects of the invention will be described with respect to later figures.

Additionally, arrow O₅ indicates that order information in connection with the exchange 138 is communicated to the transaction information database 118 (see the discussion herein with reference to FIG. 3A).

FIGS. 1 and 2 provide examples of systems according to some embodiments of the invention. It is to be understood, however, that various other systems are contemplated by the invention. For example, the systems and methods of the present invention can be used in various different types of computerized systems which in various ways facilitate transactions. Herein, “facilitate” is broadly intended to include not only systems that cause or help cause execution or settlement of transactions, but also systems that are intended to provide various other forms of assistance with respect to transacting in any type of goods or services.

FIG. 3 is a detailed block diagram of a distributed computer system 300 according to one embodiment of the invention. As depicted in FIG. 3, the customer computer 102, the mainframe computer 112, the internal trader computers 116_{a-c}, and the correspondent trader computers 130_{a-c} each comprise one or more central processing unit 310, 312, 314, 316, and one or more data storage devices 302, 304, 306, 307. The data storage device 302 of the customer client computer 102 comprises a Web browser program 308, such as, for example, Microsoft's Internet Explorer. The data storage device of the mainframe computer 112 comprises the break tracking system 114, and the break tracking system 114 comprises the break tracking application program 318 for providing a break tracking application or applications. It is to be understood that while the break tracking application program 318 is depicted as a discrete item within the break tracking system 114, this is for conceptual purposes only, and the break tracking application program 318 can be a modular part of the break tracking system 114, or can be incorporated into the break tracking system 114 itself.

The data storage devices 302, 304, 306, 307 can comprise various amounts of RAM for storing computer programs and other data. In addition, the computers 102, 112, 116_{a-c}, 130_{a-c} can include other components typically found in computers, including one or more output devices such as monitors or other displays or presentations, other fixed or removable data storage devices such as hard disks, floppy disk drives, DVD drives, and CD-ROM drives, as well as one or more input devices, such as keyboards, pointing devices such as mouse pointing devices, non-pointing input devices, or speech recognition systems. Generally, the computers 102, 112, 116_{a-c}, 130_{a-c} operate under and execute computer programs under the control of an operating system, such as Windows, Macintosh, UNIX, etc.

Generally, the computer programs of the present invention are tangibly embodied in a computer-readable medium, e.g., one or more data storage devices attached to a computer. Under the control of an operating system, computer programs may be loaded from data storage devices into computer RAM for subsequent execution by the CPU. The computer programs comprise instructions which, when read and executed by the computer, cause the computer to perform the steps necessary to execute elements of the present invention.

The break tracking system 114 is broadly intended to represent any and all computer code, programming, applications, software, etc. used to carry out break tracking functions as described herein. “Break tracking”, as used herein, is broadly intended to include the various functions of the break tracking system 114 as described herein, including, among other things, identification of breaks, identification of break owners and other entities associated with breaks, or with orders associated with breaks, or with transactions associated with one or more breaks, and providing of a break tracking application or applications.

FIG. 3A is a block diagram of a system 350 according to one embodiment of the invention. Depicted within the extended financial services system 108 are the transaction information database 118, the mainframe computer 112, and a trader 350. Depicted outside the extended financial services system 108 are a contra party 352, a market 354, a utility 356, and a clearing corporation 358. The contra party 352, the market 354, the utility 356, the clearing corporation 358, and the trader 350 include associated computers or computer systems. The contra party 352 can be, for example, a contra broker or can be a Specialist. The market can be, for example, a listed exchange such as the New York Stock Exchange. The clearing corporation can be, for example, the National Securities Clearing Corporation (NSCC) (or the Depository Trust and Clearing Corporation (DTCC)), or other provider of centralized clearance services.

Orders are communicated by the contra party 352 and the trader computer 350 to the market 354 for execution. Market-based, or “Streetside,” information concerning locked-in trades is communicated to the utility 356 for comparison. The contra party 352, and an entity within the extended financial services system 108 associated with the trader 350, are notified of compared and uncompared trades. Compared trades information is communicated from the utility 356 to the clearing corporation 358. The clearing corporation 358 aggregates trade information and communicates the aggregated information to the transaction information database 118 (whether directly or through intermediaries). Additionally, trade information processed within the extended financial services system 108 is communicated to the transaction information database 118. As such, the transaction information database contains “streetside” trade information as well as trade information that is internal to the extended financial services system 108. The mainframe computer 112 utilizes the brake tracking system 114 to compare information concerning trades so as to identify and track any breaks.

FIG. 4 is a flow diagram of a method 400 according to one embodiment of the invention, including providing electronic notification of a break. At step 402, the break tracking system 114 is utilized to identify a break. In some embodiments, the break tracking system 114 able to identify breaks occurring in transactions involving both over-the-counter and listed securities or equities.

At step 404, the break tracking system 114 is utilized to identify a first set of at least one user of the extended financial services system 108 evidenced as being associated with the break. “Evidence” can include various information stored in the transaction information database 118 or elsewhere.

It is to be noted that, in some embodiments, it is possible that a user evidenced as a break owner turns out to not in fact be the break owner. In some embodiments, in such instances, the inaccurate identification of the break owner can be corrected manually, such as through a break tracking application, or otherwise. In addition, in some embodiments, other information associated with breaks can be manually changed by users, or certain of them, including routing information pertaining to electronic notification of a break or pertaining to information indicating a party responsible for taking action to facilitate resolution of a break. In some embodiments, any such changes are reflected by updating the transaction information database 118 accordingly.

Furthermore, in some embodiments, after making a correction, the break tracking system can be utilized to perform its various functions, as described herein, taking the change into account, and to update the transaction information database accordingly. For example, in instances where a break owner has been manually corrected using a break tracking application, the break tracking system 118 can be utilized to correct other identified associated users, such as a contra entity, accordingly, and, in some embodiments, to provide electronic notification of the break to the corrected break owner. In some embodiments, the break tracking system can be utilized to provide electronic notification to initially inaccurately identified users regarding the inaccurate identification.

At step 406, the break tracking system 114 is utilized to provide electronic notification of the break to at least one user of the first set. In some embodiments of the invention, the at least one user of the first set is the break owner. In other embodiments the contra entity or other entities are also identified and notified of the break at step 406. The electronic notification can take any number of forms, for example, e-mail, window, or other message, or an electronic posting at a Web site visited by the user. In some embodiments, a break owner, notified of the break, is required to respond in some way to facilitate resolution of the break, such as through a break tracking application.

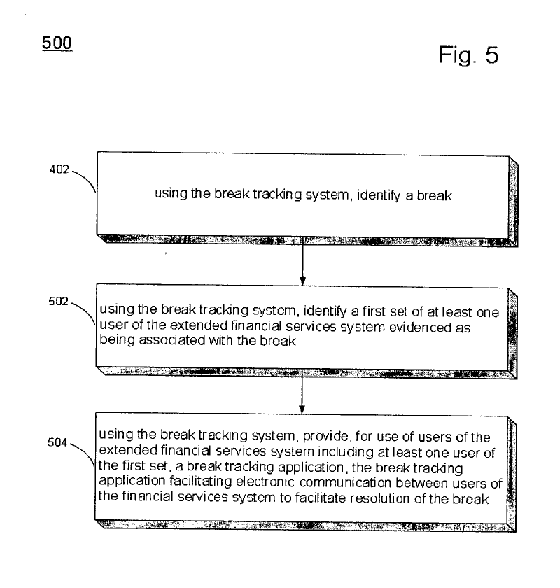

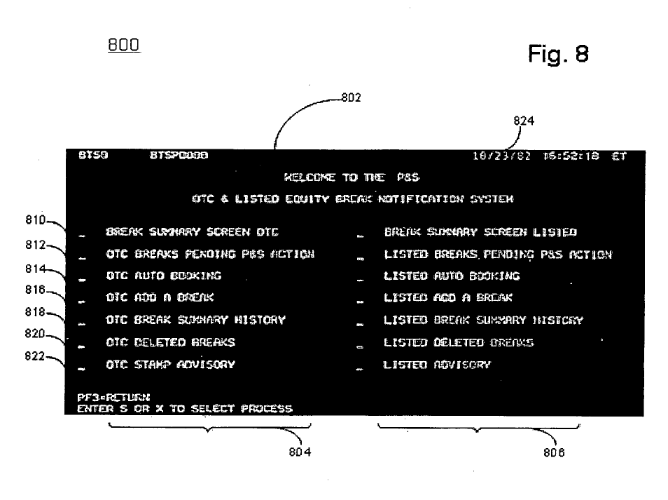

FIG. 5 is a flow diagram of a Method 500 according to another embodiment of the invention, including providing a break tracking application. At step 402, the break tracking system 114 is utilized to identify a break. At step 502, the break tracking system 114 is utilized to identify a first set of at least one user of the extended financial services system 108 evidenced as being associated with the break. At step 504, the break tracking application program 318 of the break tracking system 114 is utilized to provide, for the use of users of the extended financial services system 108 including at least one user of the first set, a break tracking application, the break tracking application facilitating electronic communication between users of the extended financial services system 108, the communication being for facilitating resolution of the break. The break tracking application can provide users with information useful in facilitating resolution of the break, such as information saved in the transaction information database 118, as well as provide users with an opportunity to electronically communicate with each other regarding the break and to facilitate its resolution. One embodiment of a break tracking application is described in detail herein with respect to FIGS. 8-18.

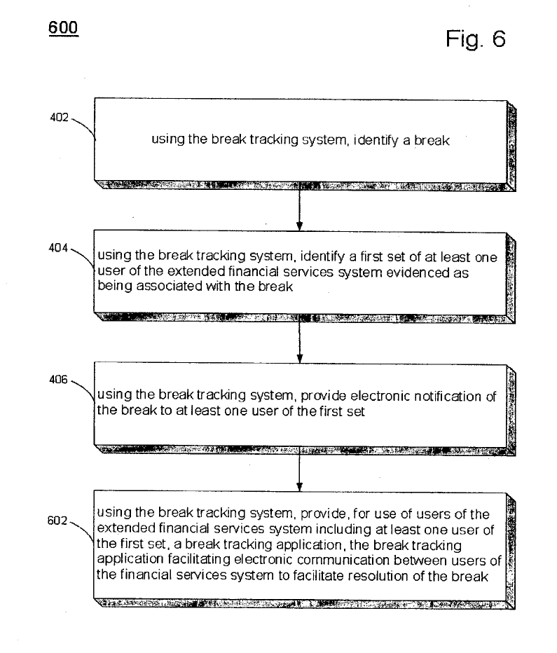

FIG. 6 is a flow diagram of a method 600 according to another embodiment of the invention, including providing electronic notification of a break and providing a break tracking application. At step 402, the break tracking system 114 is utilized to identify a break. At step 404, the break tracking system 114 is utilized to identify a first set of at least one user of the extended financial services system 108 evidenced as being associated with the break. At step 406, the break tracking system 114 is utilized to provide electronic notification of the break to at least one user of the first set. At step 602, the break tracking application program 318 of the break tracking system 114 is utilized to provide, for the use of users of the extended financial services system 108 including at least one user of the first set, a break tracking application, the break tracking application facilitating electronic communication between users of the extended financial services system 108, the communication being for facilitating resolution of the break.

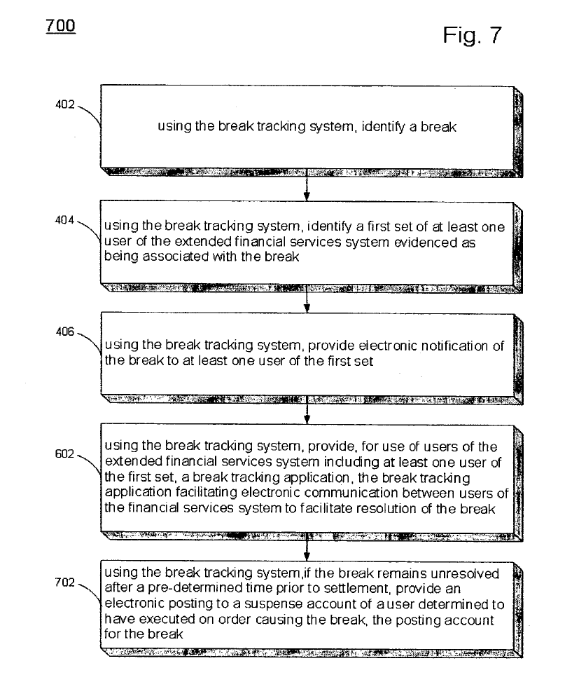

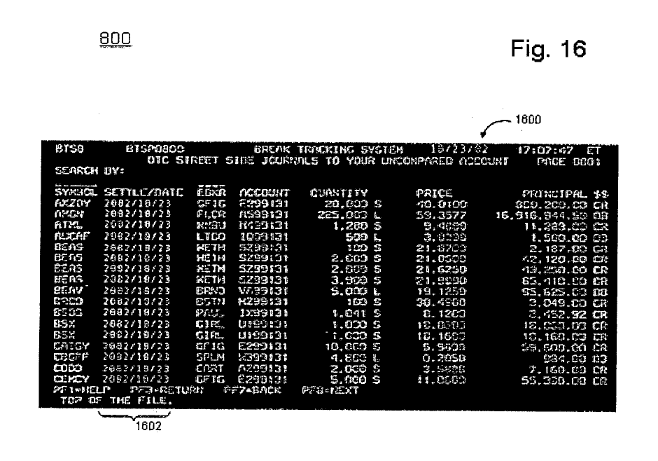

FIG. 7 is a flow diagram of a method 700 according to another embodiment of the invention, including providing electronic notification of a break, providing a break tracking application, and providing an electronic posting to a user's account to account for the break. Steps 402, 404, 406, and 602 of method 700 are identical to those of method 600 depicted in FIG. 6. At step 702, if the break remains unresolved after a pre-determined time prior to settlement associated with the transaction, the break tracking system 114 is utilized to provide an electronic posting to a suspense account of a user determined to be the break owner, the posting accounting for the break. FIG. 16, described below, provides an illustration of one embodiment of a display of such postings.

Various uses of the break tracking system 114 in different embodiments of the invention are discussed above. As indicated above, the break tracking system 114 is used to identify breaks. The break tracking system 114 can also be used to identify users of the extended financial services system 108 associated with a break. This can include, for example, identifying computers or computer systems which communicate or execute orders relating to a transaction, and identifying entities, such as brokers, associated with the computers or computer systems. Users identified can include users who execute orders causing a break to arise, contra users to those uses, and other users associated with the break. The break tracking system 114 can also be used to provide electronic notification of the break to certain users as well as to provide a break tracking application.

In accomplishing the above and other tasks, the mainframe computer 112 accesses and utilizes the information contained in the transaction information database 118, which, as described above, contains various information about transactions, orders relating to transactions, and associations there between, which information can be communicated to the transaction information database 118 by trader computers or computer systems involved in transactions.

In various cases, identifying a break can be less complex or more complex. In some cases, for example, a simple discrepancy in a parameter between orders which are expected to have identical parameters can be used in identifying a break. For example, a first order can indicate a quantity of 350 shares of a stock, whereas a second order which is expected to correspond to and have the same quantity term as the first order can instead indicate a quantity of 300 shares. In other cases, identifying breaks can be more difficult and a more complex task. The break tracking system 114 can utilize information in the transaction information database 118 in performing, among other things, the tasks described above, including comparing information. In cases requiring sophisticated data mining to accomplish the tasks, various data mining and data analysis programming and software readily available to the skilled artisan can be utilized.

As indicated above, in some embodiments, the break tracking application program 318 of the break tracking system 114 is utilized to provide a break tracking application to users of the extended financial services system 108. In some embodiments, this application provides a graphical user interface-based application by which users can obtain information about the break and communicate efficiently with each other to facilitate resolution of the break. In some embodiments, access to a break tracking application is made secure, for example, by requiring entry of a password, registration with the extended financial services system 108, or in some other way secured. In some embodiments, users or authorized users of the break tracking application can manipulate, using the break tracking application, information presented via the break tracking application. In some embodiments, only certain users are authorized and able to access the break tracking application, such as users determined by the break tracking system 114 to be associated with the break, to manipulate, using the break tracking application, information presented via the break tracking application. In some embodiments, the break tracking application is accessible via the Internet 104.

One embodiment of a break tracking application is described with reference to FIGS. 8-18, below, which depict a series of graphical user interface displays of a break tracking application 800.

FIG. 8 is a main menu graphical user interface 802 of one embodiment of a break tracking application 800 according to the invention. As depicted, “P & S” refers to a Purchase and Sales division of a financial service company. In some embodiments, the graphical user interface 800 is the first graphical user interface that a user of the break tracking application, although in some embodiments, a sign-on or password entry graphical user interface precedes graphical user interface 800. As depicted, a display 824 of the present date and time is provided in the upper right area of the graphical user interface 802. Various navigation options are available to users of the application 800. User can choose particular navigation options or other options, generally, by moving a position indicator over a characters, words, phrases, or symbols associated with a particular navigation option or other option.

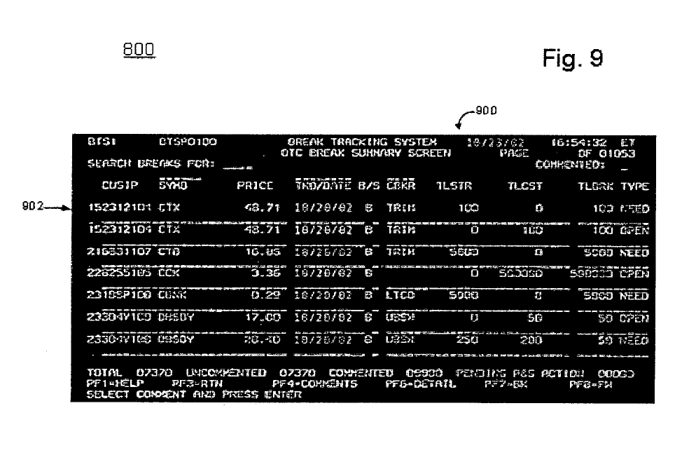

Navigation options 804 on the left side of the graphical user interface 802 are for options associated with over-the-counter (OTC) equities, and navigation options 806 on the right side of the graphical user interface 802 are for options associated with listed equities. Option 810 allows users to access a OTC break summary graphical user interface 900, depicted in FIG. 9, with information relating to breaks associated transactions involving OTC equities. Option 812 allows users to access a graphical user interface with information relating to breaks upon which the P & S division will take action, for example, action to resolve the break. Option 814 allows users to access a graphical user interface with information regarding “auto-booking” of breaks, which term refers to providing an electronic posting to a suspense account of a trader determined to have executed an order involved in the break, the posting accounting for the break, and the posting being accomplished utilizing a break tracking system.

Option 816 and option 820, respectively, allow users, or some users, to add or delete breaks utilizing the application 800. For example, in some embodiments, users can use the application 800 to add or delete breaks to correct inaccurate displayed information. This can occur, for instance, if the user has resolved a break, and therefore wishes to remove it, or if a user is aware of a break which is not reflected by the information presented by the application 800. In some embodiments, only authorized or specific users are able to make such changes, such as users associated with a break, which can include a break owner and contra entity. In some embodiments, changes, such as additions or deletions of breaks or other changes, cause information in a transaction information database, such as transaction information database 118, to be updated accordingly.

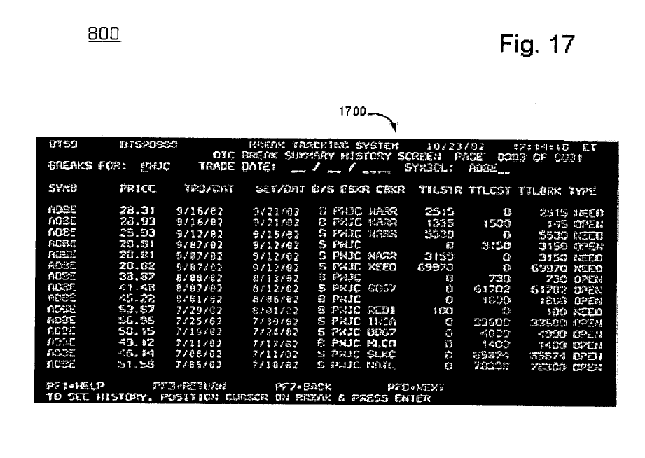

Option 818 allows users to access a break summary history graphical user interface 1700, as depicted in FIG. 17, with information relating to past breaks, which can include past breaks which have been resolved, past breaks which have not been resolved, or both, and can include information regarding whether particular breaks have been resolved or not, and whether particular breaks have led to electronic postings to suspense accounts.

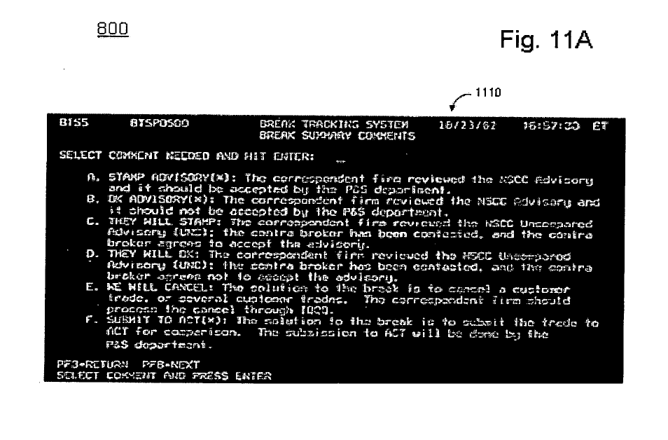

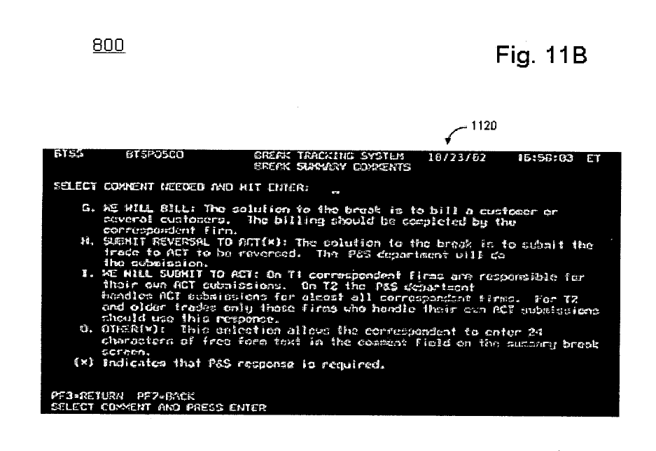

Option 822 allows users to choose pre-formulated stamp advisories, which are pre-formulated messages, presented by the application for selection by users, for facilitating resolution of breaks. Examples of such comments are depicted in graphical user interface 1100 of FIGS. 11A and 11B. By entering and posting comments regarding breaks, a user associated with a break can communication with one or more other users associated with the break, to facilitate resolution of the break. A posted electronic comment is viewable by other users of the application. In some embodiments, information contained in the transaction information database 118 includes comments information, which information is updated in transaction information database 118 in accordance with any changes, additions, or deletions made by users of the application. In some embodiments, various other information presented via the application 800, as well, is stored in the transaction information database 118, can be manipulated by users of the application, and is updated in the transaction information database 118 accordingly, by the break tracking system 114.

FIGS. 9-18 provide examples of graphical user interfaces of the application 800 which, according to various embodiments, can be accessible directly from the main menu graphical user interface 802, or can be accessible from other graphical user interfaces of the application. It is to be understood that many of the depicted graphical user interfaces are larger than a single display can show, and can therefore be, for example, scrollable via the application 800, so that users can scroll, for example, up or down, to view different portions of a graphical user interface. The depicted graphical user interfaces are therefore often only portions of a complete graphical user interface page or display unit.

FIG. 9 is the break summary graphical user interface 900 for over the counter (OTC) securities, according to one embodiment of the invention. The graphical user interface provides information associated with breaks associated with OTC equities transactions. Display row 902 provides information regarding a particular break. The column labeled “CUSIP”, having the entry, “152312104”, in some embodiments, can represent a unique identifier for the break. The column labeled “SYMB”, having the entry, “CTX”, represents a standard symbol for the associated equity. The column, “PRICE”, having the entry, “48.71”, represents a correct price associated with the transaction. The column, “TRD/DATE”, having the entry, “Oct. 20, 2002” represents the date of the customer's order. The column labeled, “B/S”, having the entry, “B” represents whether the user that is evidenced as having executed the order involved in the break was a buyer (B) or a seller (S). The column labeled, “CBKR”, having the entry, “TRIM”, represents the contra user, which, as depicted, is a broker entity referenced as “TRIM”. The column labeled, “TLSTR”, having the entry, “100”, represents the “Total Street”, which means a quantity of the security associated with the transaction having the break, as that quantity is evidenced as recorded in association with the “Street”, meaning an entity associated with Wall Street, or the New York Stock Exchange. The column labeled, “TLCST”, having the entry, “0”, represents a “Total Customer”, or a quantity of the security associated with the transaction the break, as that quantity is evidenced as recorded in association with the customer. The column, “TLBRK”, having the entry, “100”, represents the total quantity of this particular break, which arises out of a quantity discrepancy. The column labeled, “TYPE”, having the entry, “NEED”, represents information about whether any equities are needed to resolve the break.

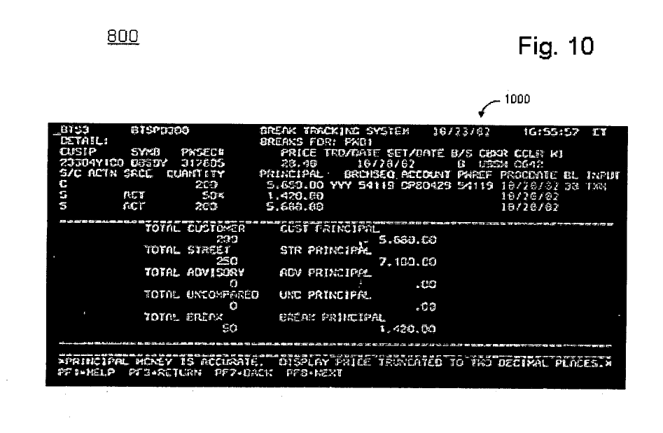

FIG. 10 is a break details graphical user interface 1000, according to one embodiment of the invention. Among the displayed details associated with the break are the associated trade date, settlement date (SET/DATE), Street total, customer total, break total, customer principal, Street principal, advisory principal, uncompared principal, and break principal.

FIGS. 11A and 11B are, respectively, a first screen display 1110 and a second screen display 1120 of a standard break comment selection graphical user interface 1100, according to one embodiment of the invention. FIG. 11B is the display that will be seen by a user who, while viewing the first screen display 1110, scrolls down, chooses the next page, or the like, to thereby cause the second screen display 1120 to appear. Each of the depicted standard comments can be selected by a user of the application 800 to be added to the information displayed by the application in connection with a particular break or breaks, and, in some embodiments, saved in the transaction information database 118. Later users of the application can then view the comment, and can add their own comment, which is one way in which the application 800 facilitates communication between users to resolve breaks.

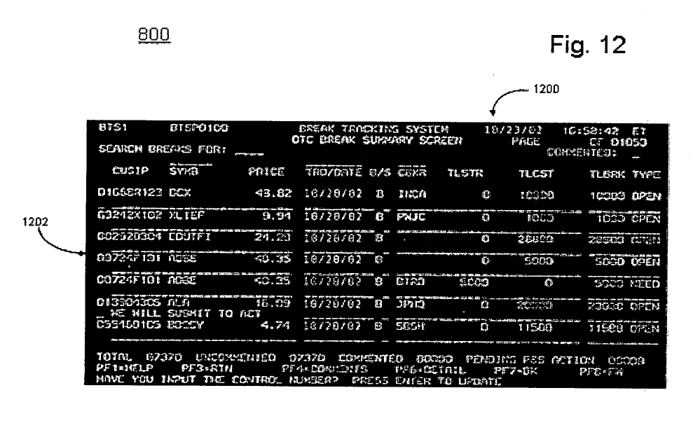

FIG. 12 is a break summary graphical user interface 1200, including a standard comment inserted by a user. In the depicted graphical user interface, a comment 1202, “WE WILL SUBMIT TO ACT”, has been inserted, to facilitate resolution of the associated break, some details of which break are displayed just above the comment 1202. The comment 1202 is one of the comments that can be selected from the standard comments presented on the second screen display 1120 depicted in FIG. 11B.

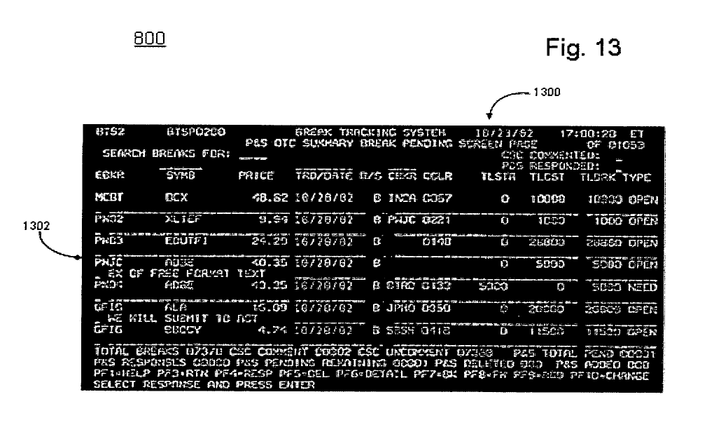

FIG. 13 is a break summary graphical user interface 1300, including a free form comment 1302 inserted by a user. As depicted in the graphical user interface 1300 of FIG. 13, a free-form comment 1302, “EX OF FREE FORMAT TEXT”, has been inserted by a user in association with the break, some details of which are displayed just above the comment 1302. The free-form comment 1302 can be any comment, which can have a particular maximum length, which is entered in some way using the application 800 by a user via the application 800, and which is to be read by another user or user of the application 800, to facilitate resolution of the break.

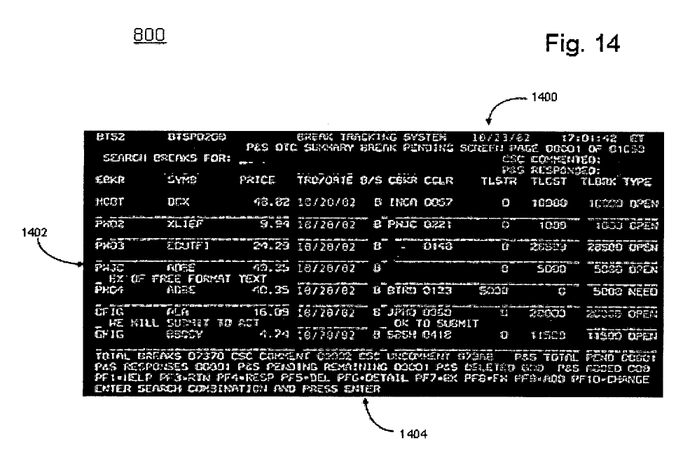

FIG. 14 is a break summary graphical user interface 1400, including a reply comment 1402 inserted by a user. The standard comment 1402, “WE WILL SUBMIT TO ACT”, was first inserted by a user in association with a break. Later, the standard comment 1404, “OK TO SUBMIT”, was inserted as a reply to comment 1402 by another user, in association with the same break. In the embodiment depicted, communication between users, including reply comments, and replies to replies, and so on, facilitates resolution of the break.

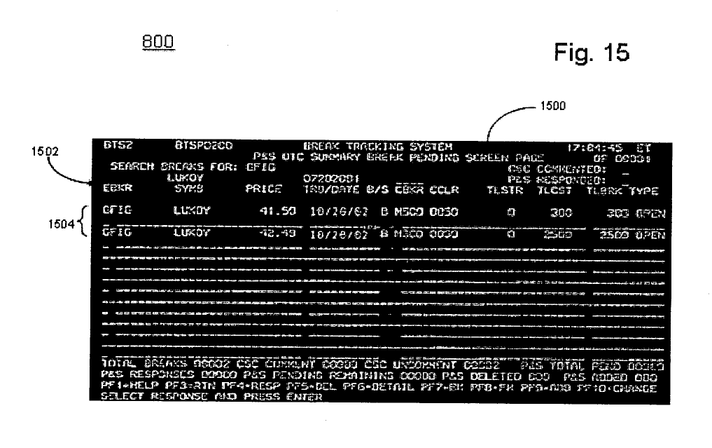

FIG. 15 is a break summary graphical user interface 1500, which results from a user search query. In the embodiment depicted, the application 800 makes use of search programming, or a search engine, as known in the art, so that a user can implement searches via the application 800, to cause the application to display information specified by the user with a search query, which query is entered using the application 800 in some way, such as by using a keyboard. The graphical user interface 1500 results from a search query to display breaks associated with the executing broker GFIG and the equity with the symbol LUKOY, as indicated by row 1502. Two rows 1504 of information are displayed, each row containing information about a break satisfying the specified search criteria.

FIG. 16 is an break auto-book graphical user interface 1600, listing breaks that will be posted to a trader's account by the break tracking system 118, i.e., auto-booked, if not resolved by a specified time, such as breaks not resolved by the day following the display date of graphical user interface 1600. Among the information displayed is the settlement date, in the column labeled, “SETTLE/DATE”.

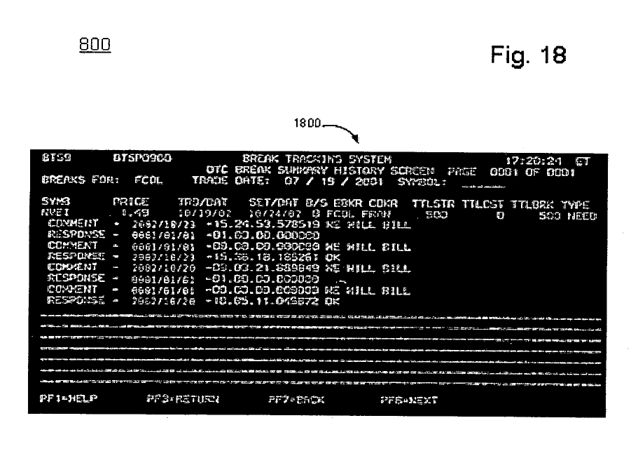

FIG. 17 is a break summary history graphical user interface 1700, providing a log of past breaks, and FIG. 18 is a break summary history graphical user interface, providing a log of past comments, including reply comments, associated with a break.

While FIGS. 8-18 describe certain aspects of the invention in connection with breaks associated with equities transactions, the invention can also be used in connection with breaks associated with various types of transactions associated with various types of securities, and rights associated with securities. For example, the invention can be used in connection with breaks associated with options.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. In a networked computer system in which transactions are facilitated, a system for tracking breaks, the system comprising:
a first set of one or more computers connected to a network, the first set of computers including a break tracking system;
a plurality of trader computers, connected to the network, for use in communicating orders associated with the transactions to a market; and
a transaction information database, accessible by at least one of the first set of computers, for storing information about the transactions, wherein the database contains at least two sets of information associated with a first transaction of the transactions, at least one of the sets of information being associated with the market, and at least one of the sets of information being associated with a trader associated with at least one of the trader computers, and wherein the break tracking system is for:
comparing the at least two sets of information to determine whether a break exists; and
if a break is determined to exist:
identifying a set of at least one trader evidenced in the networked computer system as being associated with the break; and
providing, through the network, electronic notification of the break to a first trader computer of the plurality of trader computers, the first trader computer being associated with at least one trader of the first set of at least one trader.

2. In a networked computer system for facilitating transactions, a system for tracking breaks, the system comprising:
a first set of one or more computers connected to a network, the first set of computers including a break tracking system;
a plurality of trader computers, connected to the network, for use in communicating orders associated with the transactions to a market; and
a transaction information database, accessible by at least one of the first set of computers, for storing information about the transactions, wherein the database contains at least two sets of information associated with a first transaction of the transactions, at least one of the sets of information being associated with the market, and at least one of the sets of information being associated with a trader associated with at least one of the trader computers, and wherein the break tracking system is for:
comparing the at least two sets of information to determine whether a break exists; and
if a break is determined to exist:
identifying a set of at least one trader evidenced in the networked computer system as being associated with the break; and
providing, through the network, for use of users of trader computers including at least one trader computer that is associated with at least one trader of the set of at least one trader, a break tracking application, the break tracking application facilitating electronic communication between users of trader computers, for facilitating resolution of the break.

3. In a networked computer system in which transactions are facilitated, a system for tracking breaks, the system comprising:
a first set of one or more computers connected to a network, the first set of computers including a break tracking system;
a plurality of trader computers, connected to the network, for use in communicating orders associated with the transactions to a market; and
a transaction information database, accessible by at least one of the first set of computers, for storing information about the transactions, wherein the database contains at least two sets of information associated with a first transaction of the transactions, at least one of the sets of information being associated with the market, and at least one of the sets of information being associated with a trader associated with at least one of the trader computers, and wherein the break tracking system is for:
comparing the at least two sets of information to determine whether a break exists; and
if a break is determined to exist:
identifying a set of at least one trader evidenced in the networked computer system as being associated with the break;
providing, through the network, electronic notification of the break to a first trader computer of the plurality of trader computers, the first trader computer being associated with at least one trader of the set of at least one trader; and
providing, through the network, for use of users of trader computers including at least one trader computer that is associated with at least one trader of the set of at least one trader, a break tracking application, the break tracking application facilitating electronic communication between users of trader computers, for facilitating resolution of the break.

4. The system of claim 3, wherein the first transaction is a transaction in one or more securities.

5. The system of claim 3, wherein the first transaction is a transaction in one or more options.

6. The system of claim 3, wherein each of the at least two sets of information are information about an order associated with the first transaction.

7. The system of claim 3, wherein at least one of the at least two sets of information is communicated to the transaction information database by a trader computer of the plurality of trader computers, and wherein at least one of the at least two sets of information is communicated to the transaction information database from the market.

8. The system of claim 3, wherein the set of at least one trader is evidenced in the networked computer system as being associated with the break by information stored in the transaction information database.

9. The system of claim 3, wherein the set of at least one trader comprises a trader evidenced in the transaction information database as being a break owner.

10. The system of claim 8, wherein the set of at least one trader comprises a trader evidenced in the transaction information database as being a contra entity.

11. The system of claim 3, wherein the plurality of trader computers comprises at least one internal trader computer and one correspondent trader computer.

12. The system of claim 3, wherein the break tracking application provides displays to users of the break tracking application containing information associated with breaks.

13. The system of claim 12, wherein the break tracking application provides the displays in accordance with user search queries.

14. The system of claim 12, wherein users of the break tracking application can insert comments into the displays, and wherein the comments are saved in the transaction information database, and wherein user of the break tracking application can view the inserted comments and insert reply comments to the inserted comments.

15. The system of claim 12, wherein at least some of the users can make changes to information associated with breaks using the application.

16. The system of claim 12, wherein the break tracking system causes information in the transaction information database to be updated to reflect the changes.

17. The system of claim 12, wherein the break tracking application updates the identified at least one trader in accordance with the changes.

18. The system of claim 3, wherein the break tracking system compares the at least two sets of information using data mining programming.

19. In a networked computer system in which transactions are facilitated, a system for tracking breaks, the system comprising:
a first set of one or more computers connected to a network, the first set of computers including a break tracking system;
a plurality of trader computers, connected to the network, for use in communicating orders associated with the transactions to a market; and
a transaction information database, accessible by at least one of the first set of computers, for storing information about the transactions, wherein the database contains at least two sets of information associated with a first transaction of the transactions, at least one of the sets of information being associated with the market, and at least one of the sets of information being associated with a trader associated with at least one of the trader computers, and wherein the break tracking system is for:
comparing the at least two sets of information to determine whether a break exists; and
if a break is determined to exist:
identifying a set of at least one trader evidenced in the networked computer system as being associated with the break;
providing, through the network, electronic notification of the break to a first trader computer of the plurality of trader computers, the first trader computer being associated with at least one trader of the first set of at least one trader;
providing, through the network, for use of users of trader computers including at least one trader computer that is associated with at least one trader of the set of at least one trader, a break tracking application, the break tracking application facilitating electronic communication between users of trader computers, for facilitating resolution of the break; and
if the break remains unresolved after a predetermined time prior to settlement associated with the first transaction, providing an electronic posting to a suspense account of a trader determined to have executed an order associated with the break, the posting accounting for the break.

20. In a networked computer system in which transactions are facilitated, the networked computer system comprising a first set of one or more computers including a break tracking system, a plurality of trader computers for use in communicating orders associated with the transactions to a market, and a transaction information database, accessible by at least one of the first set of computers, for storing information about the transactions, wherein the database contains at least two sets of information associated with a first transaction of the transactions, at least one of the sets of information being associated with the market, and at least one of the sets of information being associated with a trader associated with at least one of the trader computers, a method for tracking breaks, the method comprising:
utilizing the break tracking system, comparing the at least two sets of information to determine whether a break exists; and
if a break is determined to exist:
identifying a set of at least one trader evidenced in the networked computer system as being associated with the break; and
providing, through the network, electronic notification of the break to a first trader computer of the plurality of trader computers, the first trader computer being associated with at least one trader of the first set of at least one trader.

21. In a networked computer system in which transactions are facilitated, the networked computer system comprising a first set of one or more computers including a break tracking system, a plurality of trader computers for use in communicating orders associated with the transactions to a market, and a transaction information database, accessible by at least one of the first set of computers, for storing information about the transactions, wherein the database contains at least two sets of information associated with a first transaction of the transactions, at least one of the sets of information being associated with the market, and at least one of the sets of information being associated with a trader associated with at least one of the trader computers, a method for tracking breaks, the method comprising:
utilizing the break tracking system, comparing the at least two sets of information to determine whether a break exists; and
if a break is determined to exist:
identifying a set of at least one trader evidenced in the networked computer system as being associated with the break; and
providing, through the network, for use of users of trader computers including at least one trader computer that is associated with at least one trader of the set of at least one trader, a break tracking application, the break tracking application facilitating electronic communication between users of trader computers, for facilitating resolution of the break.

22. In a networked computer system in which transactions are facilitated, the networked computer system comprising a first set of one or more computers including a break tracking system, a plurality of trader computers for use in communicating orders associated with the transactions to a market, and a transaction information database, accessible by at least one of the first set of computers, for storing information about the transactions, wherein the database contains at least two sets of information associated with a first transaction of the transactions, at least one of the sets of information being associated with the market, and at least one of the sets of information being associated with a trader associated with at least one of the trader computers, a method for tracking breaks, the method comprising:
utilizing the break tracking system, comparing the at least two sets of information to determine whether a break exists; and
if a break is determined to exist:
identifying a set of at least one trader evidenced in the networked computer system as being associated with the break;
providing, through the network, electronic notification of the break to a first trader computer of the plurality of trader computers, the first trader computer being associated with at least one trader of the first set of at least one trader; and
providing, through the network, for use of users of trader computers including at least one trader computer that is associated with at least one trader of the set of at least one trader, a break tracking application, the break tracking application facilitating electronic communication between users of trader computers, for facilitating resolution of the break.

23. In a networked computer system in which transactions are facilitated, the networked computer system comprising a first set of one or more computers including a break tracking system, a plurality of trader computers for use in communicating orders associated with the transactions to a market, and a database, accessible by at least one of the first set of computers, for storing information about the transactions, a method for tracking breaks, the method comprising:
communicating to and storing in the database at least two sets of information associated with a first transaction of the transactions, at least one of the sets of information being associated with the market, and at least one of the sets of information being associated with a trader associated with at least one of the trader computers;
utilizing the break tracking system, comparing the at least two sets of information to determine whether a break exists; and
if a break is determined to exist:
identifying a set of at least one trader evidenced in the networked computer system as being associated with the break;
providing, through the network, electronic notification of the break to a first trader computer of the plurality of trader computers, the first trader computer being associated with at least one trader of the first set of at least one trader; and
providing, through the network, for use of users of trader computers including at least one trader computer that is associated with at least one trader of the set of at least one trader, a break tracking application, the break tracking application facilitating electronic communication between users of trader computers, for facilitating resolution of the break.

24. The method of claim 23, comprising identifying a set of at least one trader is evidenced in the networked computer system as being associated with the break by information stored in the database.

25. The method of claim 23, wherein identifying a set of at least one trader comprises identifying a set of at least one trader evidenced in the transaction information database as being a break owner.

26. The method of claim 23, wherein identifying a set of at least one trader comprises identifying a set of at least one trader evidenced in the transaction information database as being a contra entity.

27. The method of claim 23, wherein the break tracking application provides displays to users of the break tracking application containing information associated with breaks.

28. The method of claim 27, wherein the break tracking application provides the displays in accordance with user search queries.

29. The method of claim 27, wherein users of the break tracking application can insert comments into the displays, and wherein the comments are saved in the database, and wherein users of the break tracking application can view the inserted comments and insert reply comments to the inserted comments.

30. The method of claim 27, wherein at least some of the users can make changes to information associated with breaks using the application.

31. The method of claim 30, wherein the break tracking system causes information in the database to be updated to reflect the changes.

32. The method of claim 31, wherein the break tracking application updates the identified at least one trader in accordance with the changes.

33. The method of claim 23, wherein the break tracking system compares the at least two sets of information using data mining programming.

34. In a networked computer system in which transactions are facilitated, the networked computer system comprising a first set of one or more computers including a break tracking system, a plurality of trader computers for use in communicating orders associated with the transactions to a market, and a transaction information database, accessible by at least one of the first set of computers, for storing information about the transactions, wherein the database contains at least two sets of information associated with a first transaction of the transactions, at least one of the sets of information being associated with the market, and at least one of the sets of information being associated with a trader associated with at least one of the trader computers, a method for tracking breaks, a method for tracking breaks, the method comprising:
utilizing the break tracking system, comparing the at least two sets of information to determine whether a break exists; and
if a break is determined to exist:
identifying a set of at least one trader evidenced in the networked computer system as being associated with the break;
providing, through the network, electronic notification of the break to a first trader computer of the plurality of trader computers, the first trader computer being associated with at least one trader of the first set of at least one trader;
providing, through the network, for use of users of trader computers including at least one trader computer that is associated with at least one trader of the set of at least one trader, a break tracking application, the break tracking application facilitating electronic communication between users of trader computers, the electronic communication being for facilitating resolution of the break; and
if the break remains unresolved after a predetermined time prior to settlement associated with the first transaction, providing an electronic posting to a suspense account of a trader determined to have executed an order associated with the break, the posting accounting for the break.

35. In a networked computer system in which transactions are facilitated, the networked computer system comprising a first set of one or more computers including a break tracking system, a plurality of trader computers for use in communicating orders associated with the transactions to a market, and a transaction information database, accessible by at least one of the first set of computers, for storing information about the transactions, wherein the database contains at least two sets of information associated with a first transaction of the transactions, at least one of the sets of information being associated with the market, and at least one of the sets of information being associated with a trader associated with at least one of the trader computers, a computer usable medium storing program code which, when executed by the mainframe computer, causes the mainframe computer to execute a method for tracking breaks, the method comprising:
utilizing a break tracking system executed by the mainframe computer, comparing the at least two sets of information to determine whether a break exists; and
if a break is determined to exist:
identifying a set of at least one trader evidenced in the networked computer system as being associated with the break;
providing, through the network, electronic notification of the break to a first trader computer of the plurality of trader computers, the first trader computer being associated with at least one trader of the first set of at least one trader; and
providing, through the network, for use of users of trader computers including at least one trader computer that is associated with at least one trader of the set of at least one trader, a break tracking application, the break tracking application facilitating electronic communication between users of trader computers, for facilitating resolution of the break.
